(19) United States
(12) Patent Application Publication
(10) Pub. No.: US 2022/0066242 A1
(43) Pub. Date: Mar. 3, 2022

(54) DEVICE THAT ADJUSTABLY AND DISCREETLY OBSTRUCTS PERIPHERAL VISION

(71) Applicant: Christian Ryan Leonardo, Hong Kong (HK)

(72) Inventor: Christian Ryan Leonardo, Hong Kong (HK)

(21) Appl. No.: 17/140,078

(22) Filed: Jan. 3, 2021

Related U.S. Application Data
(60) Provisional application No. 63/090,183, filed on Oct. 10, 2020.
(60) Provisional application No. 63/072,185, filed on Aug. 30, 2020.

(51) Int. Cl. G02C 7/16; G02C 9/04; G02C 11/00

(52) U.S. Cl. CPC G02C 7/165; G02C 11/12; G02C 9/04

(57) ABSTRACT

A device for adjustably and discreetly obstructing peripheral vision. The device is in the form of an eyewear that comprises a cover with viewing windows that accommodate a range of possible positions of pupils, a set of substitutable pairs of gates each with apertures of different design, a repositioning mechanism enabling lateral repositioning of said aperture, a frame, a wearing component, and a pair of lenses. Vision through a portion of the viewing windows is enabled through said apertures, which are adjusted at will to suit the user's particular pupillary distance, and the shape and size of the object intentionally being viewed. Said lenses substantially obscure the cover and gates so that obstruction of peripheral vision is done discreetly.

### CROSS-REFERENCE TO RELATED APPLICATIONS

Provisional application No. 63/090,183, filed on Oct. 10, 2020 and Provisional application No. 63/072,185, filed on Aug. 30, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention relates to the field of eyewear, and particularly to eyewear that obstructs peripheral vision.

Peripheral vision may be defined as encompassing all matter in the environment except for the particular object intentionally being viewed. In the context of book reading for example, peripheral vision may be defined as all matter in sight except for the book. Peripheral vision represents a major portion of human field of vision as while the latter spans about 200 degrees horizontally and 135 degrees vertically, only its innermost portion of about 30 degrees may be necessary for viewing object crucial to certain activities that require mental concentration. In fact, foveal vision, which enables the sharp visual detail required for reading may be estimated to account for only the innermost 2 degrees of human field of vision.

Matter within peripheral vision may unnecessarily occupy a portion of a person's awareness and pose distractions from pertinent activity. Obstruction of peripheral vision may therefore improve mental concentration. However, practical obstruction of peripheral vision is hindered by the fact that its composition varies according to the relative position of the pupils or pupillary distance and the shape and size of the object intentionally being viewed. A permanently fixed configuration would be ineffective since pupillary distance varies across individuals with average ranging from 54 mm to 68 mm for adults and from 41 mm to 55 mm for children, while the shape and size of the object being viewed varies according to the situation. As well, the act of obstruction is likely to attract unwanted attention if done obviously in public. Discomfort towards unwanted attention from other people could ultimately discourage obstruction of peripheral vision.

### BRIEF SUMMARY OF THE INVENTION

The preferred embodiment of the invention is that of a device in the form of an eyewear that adjustably and discreetly obstructs peripheral vision. It can be adjusted at will to suit a user's particular pupillary distance, as well as the shape and size of the object intentionally being viewed. The device ostensibly appears as normal sunglasses so that said obstruction is done discreetly while in public.

The device solves the problem that a permanently fixed configuration for obstruction of peripheral vision would be ineffective across various permutations of pupillary distance, which varies across individuals as influenced by age and genetics, and shape and size of the object being viewed, which could be any of various types. It solves this problem through a system that enables adjustment of the position, shape, and size of a pair of apertures. By selecting the pair of gates with the most suitable apertures and repositioning them until foveal vision is accessed through the apertures, the user is able to view the pertinent object while peripheral vision is effectively obstructed by other parts of the device.

The device also solves the problem that obstruction of peripheral vision is likely to attract unwanted attention from other people when done obviously in public. It solves this problem through obscurement by lenses, which reduce the amount of light transmitted, of the parts of the device that obstruct peripheral vision such that said parts become non-obvious to other people. With said lenses, the device obstructs peripheral vision in a discreet manner.

### BRIEF DESCRIPTION OF THE SEVERAL VIEWS OF THE DRAWING(S)

FIG. 1 is a front view of the preferred embodiment of the invention in a use position.

FIG. 2 is an overall perspective view of the embodiment recited in FIG. 1 with an exploded view of lenses and gates.

FIG. 3 is a front view of the embodiment recited in FIG. 1, but with lenses removed.

FIG. 4 is a rear view of the embodiment recited in FIG. 1, but with lenses removed.

FIG. 5 is a section view taken along the line 5-5 of FIG. 4.

FIG. 6 is a rear view of the embodiment recited in FIG. 1, but with a different pair of gates now substituted for the original pair of gates.

FIG. 7 is a perspective view of an alternative embodiment including a shield.

FIG. 8 is a section view taken along the line 8-8 of FIG. 7.

FIG. 9 is a rear view of another embodiment wherein the solid parts of shield, repositioning mechanism, gates, and cover with the exception of the viewing window are translucent.

FIG. 10 is a section view taken along the line 10-10 of FIG. 9.

FIG. 11 is a front view of a different embodiment that is removably secured by wearing component to an eyewear.

FIG. 12 is an overall perspective view of the embodiment recited in FIG. 11 with an exploded view of an adapter.

FIG. 13 is a rear view of the embodiment recited in FIG. 11.

FIG. 14 is a section view taken along the line 14-14 of FIG. 13.

FIG. 15 is a section view taken along the line 15-15 of FIG. 13.

### DETAILED DESCRIPTION OF THE INVENTION

As this invention is susceptible to embodiments in different forms, the following description discloses only certain embodiments of the invention. Since the description includes some but not all embodiments of the invention, the invention should not be construed as limited to the embodiments described herein. The invention is best defined by the appended claims of this application.

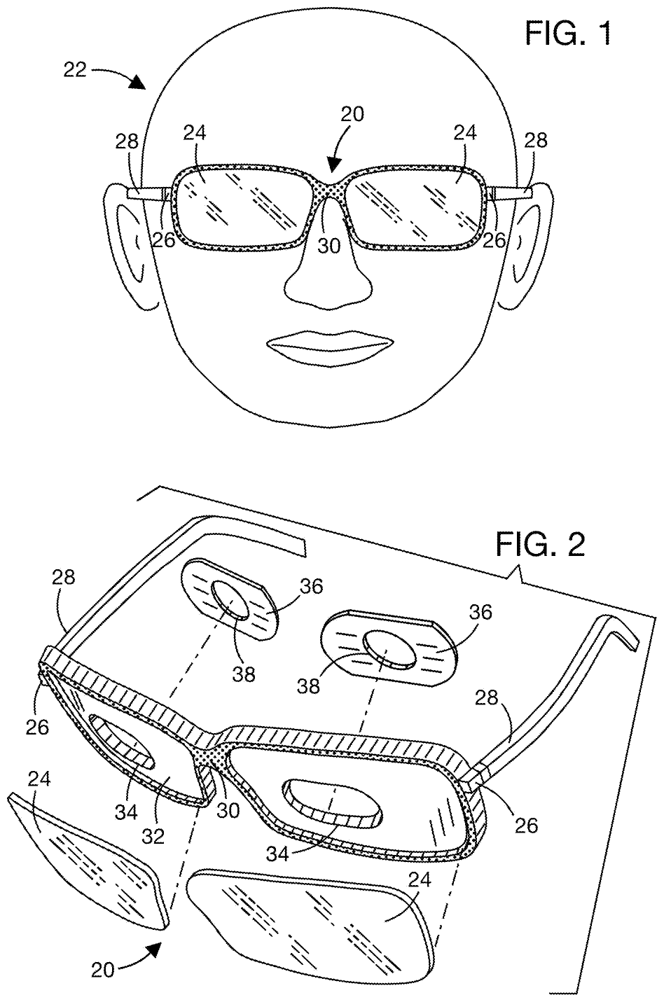

FIG. 1 to FIG. 6 shows the preferred embodiment of the invention, said preferred embodiment being the device eyewear 20. FIG. 1 is a front view showing eyewear 20 in a use position as it ostensibly appears as normal sunglasses. User 22 discreetly blocks his peripheral vision by wearing eyewear 20, the parts of which that obstruct peripheral vision are obscured behind lenses 24 that reduce the amount of transmitted light due to reflective optical coating. As the anterior side of lenses 24 are brighter than the posterior side when eyewear 20 is worn, reflection at the anterior side overwhelms the appearance of the parts that obscure peripheral vision such that said parts become non-obvious to other people. Lenses 24 therefore enable to be done in a discreet manner while in public, the obstruction of peripheral vision by eyewear 20. Eyewear 20 is worn using wearing component that are herein represented by end pieces 26 and temples 28. End pieces 26 are joined to frame 30, the rims of which removably secures lenses 24. FIG. 2 to FIG. 6 shows eyewear 20 with more detail.

FIG. 2 is an overall perspective view of the embodiment recited in FIG. 1 with an exploded view of lenses 24. Lenses 24 had been unsecured from the rims of frame 30, thus revealing cover, herein represented by cover-a 32, which is joined to frame 30. Cover-a 32 includes a pair of viewing windows, herein represented by viewing windows-a 34 in the form of laterally expanded holes. Also shown in exploded view are pair of gates for selectively obstructing vision herein represented by gates-a 36, which are characterized by component apertures-a 38 in the form of circular holes. The solid parts of cover-a 32 and gates-a 36 are opaque.

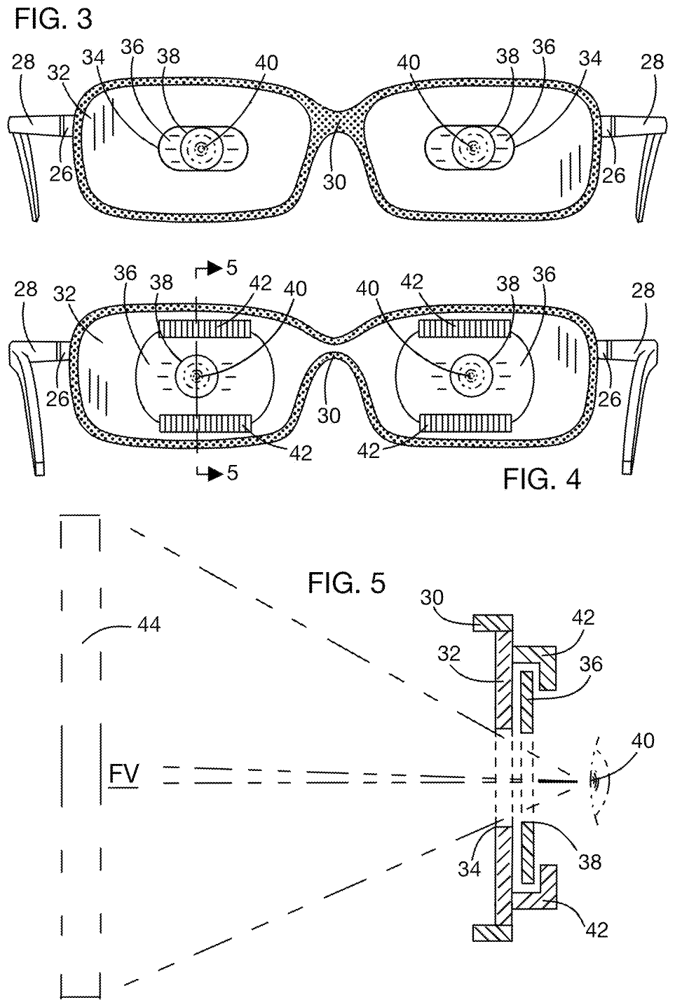

FIG. 3 is a front view of the embodiment recited in FIG. 1, but with lenses 24 that were originally adjacent to cover-a 32 now removed. Cover-a 32 is situated in front of the area within and surrounding the eye sockets of the user, such that pair of viewing windows-a 34, the size and position of which encompasses a range of possible positions of pupils 40, are situated in front of the eyes. Pair of gates-a 36 are removably secured behind cover-a 32 and are partly visible through viewing windows-a 34. Gates-a 36 overlaps with and partially blocks viewing windows-a 34. Vision through a portion of windows-a 34 is enabled through apertures-a 38, the horizontal length of which is shorter than that of windows-a 34.

FIG. 4 is a rear view of the embodiment recited in FIG. 1, but with lenses 24 removed. The embodiment additionally comprises a repositioning mechanism herein represented by rails 42 that are permanently joined to cover-a 32 and hold the top and bottom edges of gates-a 36. As a repositioning mechanism, rails 42 enable lateral repositioning of apertures-a 38 through repositioning of gates-a 36, which selectively block a portion of viewing windows-a 34. Gates-a 36 are slid along rails 42 until foveal vision is accessed through apertures-a 38 and peripheral vision is obstructed by the non-transparent parts of gates-a 36 and cover-a 32. This is achieved when apertures-a 38 are aligned with viewing windows-a 34 and pupils 40 such as at line 5-5, at which point eyewear 20 has been adjusted to suit the pupillary distance of user 22.

FIG. 5 is a section view taken along the line 5-5 of FIG. 4 illustrating pupil 40 is aligned with aperture-a 38 and viewing window-a 34. The object being intentionally viewed, herein represented by item 44 is seen with pupil 40 as foveal vision, FV, is accessed through aperture-a 38 and peripheral vision is obstructed by the non-transparent parts of gates-a 36 and cover-a 32.

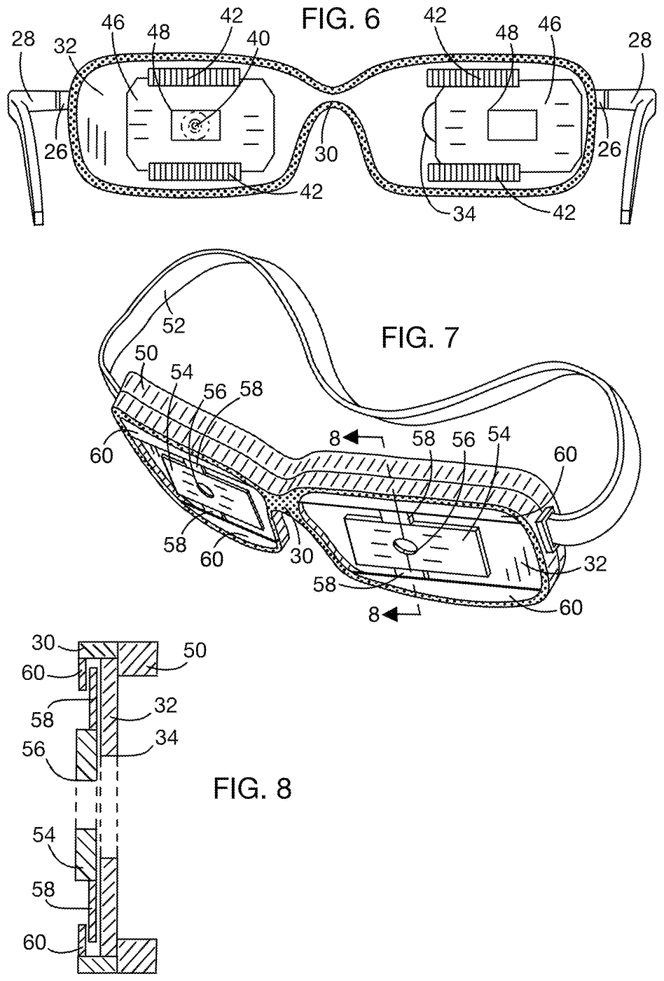

FIG. 6 is a rear view of the embodiment recited in FIG. 1, but with a different pair of gates, gates-b 46 now substituted for the original pair of gates. Gates-b 46 are characterized by component apertures-b 48 in the form of rectangular holes that are more suitable for viewing rectangular objects such as a computer screen. One of gates-b 46 is already removably secured while the other is in the process of being slid into one of the pairs of rails 42. Pair of gates-b 46 is a constituent of a set of substitutable pairs of gates, wherein each member of a particular pair shares the same design of aperture, which in turn varies from those of other pairs. Eyewear 20 has been adjusted to suit the shape and size of the particular object being intentionally viewed when the pair of gates with the most appropriate shape and size of aperture is selected and utilized.

The embodiment recited in FIG. 1 to FIG. 6 comprise frame 30, pair of lenses 24, a wearing component comprising end pieces 26 and temples 28, and a system of cover-a 32 with viewing windows-a 34, repositioning mechanism in the form of rails 42, and set of substitutable pairs of gates, gates-a 36 and gates-b 46, each pair with a different design of aperture. The embodiment can be manufactured with a variety of material using a variety of methods. However with respect to the frame 30, end pieces 26, cover-a 32, and rails 42, the preferred manufacturing mode is plastic injection molding through which said parts are molded altogether into a single unit. Pair of lenses 24, temples 28, gates-a 36, and gates-b 46 can be manufactured separately.

FIG. 7 and FIG. 8 show an alternative embodiment including a shield, herein represented by shield-a 50, and a wearing component herein represented by strap 52, which is joined to shield-a 50 and frame 30. FIG. 7 is a perspective view showing that shield-a 50 is joined to the posterior side of frame 30 and extended rearward so as to enhance the obstruction of peripheral vision. This embodiment also includes pair of gates-c 54, which are characterized by component apertures-c 56 in the form of smaller circular holes. Gates-c 54 are secured by repositioning mechanism comprising tongues-c 58, which are permanently joined to gates-c 54, and barriers-c 60, which are permanently joined to frame 30. Tongues-c 58 are of shorter horizontal length than barriers-c 60 so that gates-c 54 can be laterally repositioned as tongues-c 58 slide alongside barriers-c 60.

FIG. 8 is a section view taken along the line 8-8 of FIG. 7 illustrating that gate-c 54 is secured at the anterior side of cover-a 32 by tongues-c 58 and barriers-c 60. Frame 30, cover-a 32, and shield-a 50 are all joined permanently to each other.

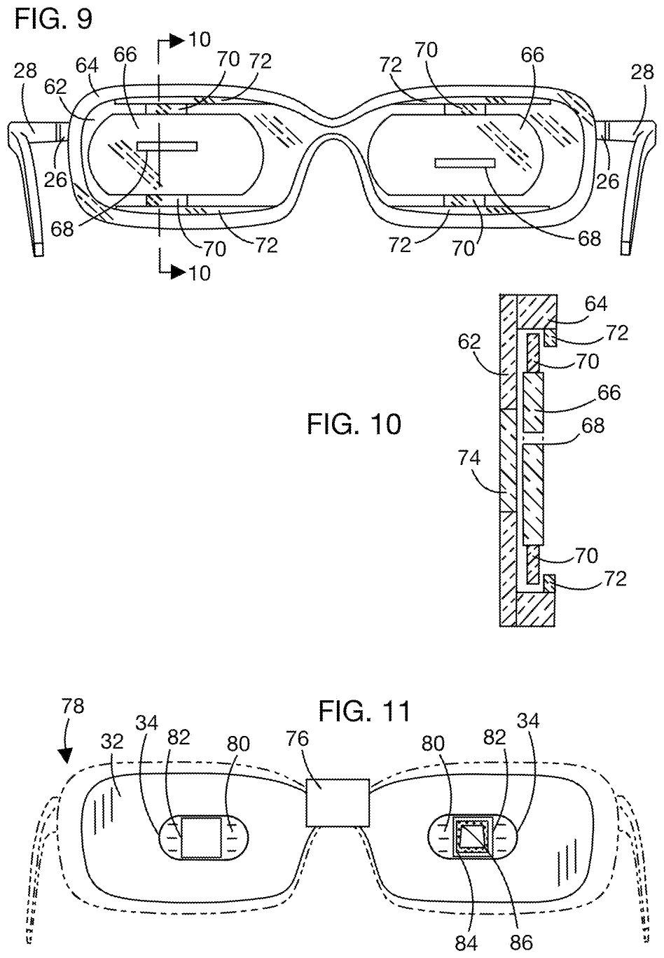

FIG. 9 and FIG. 10 show another embodiment comprising a cover herein represented by cover-b 62, shield-b 64, and gates-d 66, which are characterized by component apertures-d 68 in the form of slits suitable for viewing individual lines of text within a paragraph. FIG. 9 is a rear view showing that apertures-d 68 are not at the vertical center of gates-d 66 and therefore can be vertically repositioned by rearranging gates-d 66 via 180-degree rotation about the sagittal axis. Gates-d 66 are removably secured by a repositioning mechanism comprising tongues-d 70, which are permanently joined to gates-d 66, and barriers-d 72, which are permanently joined to shield-b 64. Shield-b 64 is joined to end pieces 26, which are joined to temples 28.

FIG. 10 is a section view taken along the line 10-10 of FIG. 9 illustrating that gate-d 66 is removably secured at the posterior side of cover-b 62 by tongues-d 70 and barriers-d 72. Tongues-d 70 had been inserted in front of barriers-d 72 by bending gate-d 66, which is flexible and can be removed in the same manner. Shield-b 64 is permanently joined to cover-b 62. This view also shows that cover-b 62 includes window-b 74, which is a transparent material instead of a hole. The solid parts of shield-b 64, tongues-d 70, barriers-d 72, gates-d 66, and cover-b 62 with the exception of a window-b 74 are all translucent to compensate for the fact that only a small amount of light passes through apertures-d 68. The embodiment still renders the environment incomprehensible but transmit some light to reduce the amount of darkness caused by the obstruction of peripheral vision.

FIG. 11 to FIG. 15 show a different embodiment that is removably secured by wearing component, which is herein represented by clip 76, to an eyewear, which is herein represented by eyeglasses 78 illustrated in phantom lines. FIG. 11 is a front view showing cover-a 32 removably secured behind eyeglasses 78 by clip 76, which clamps a part of eyeglasses 78. Gates-e 80, which are characterized by component apertures-e 82 in the form of square holes, are partly visible through viewing window-a 34. This embodiment additionally comprises an adapter, which is herein represented by adapter-a 84 that is characterized by component gap-a 86. For purpose of illustration, a portion of only one of apertures-e 82 is partly blocked by adapter-a 84. Adapter-a 84, which is a constituent of a set of adapters with varying design of gaps, has been wedged into one of apertures-e 82 so that vision through apertures-e 82 becomes entirely derived through and characterized by gap-a 86. Gap-a 86 is in the form of a trapezoidal hole, which is suitable for viewing A4 paper on desk such as when taking examinations and may help prevent cheating.

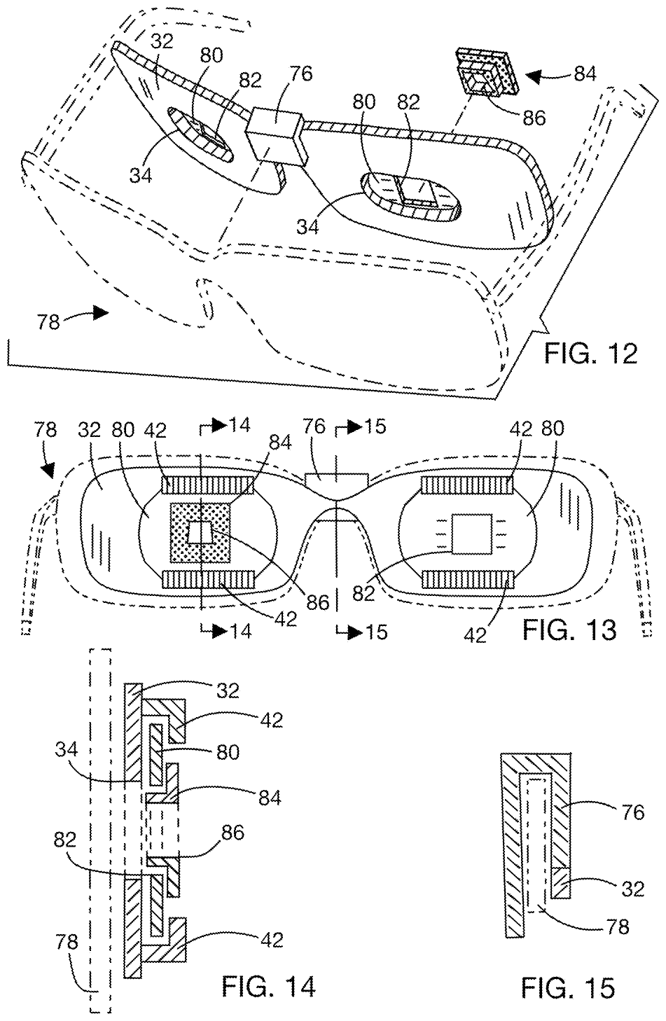

FIG. 12 is an overall perspective view of the embodiment recited in FIG. 11 with an exploded view of eyeglasses 78 and adapter-a 84. Eyeglasses 78 had been detached from clip 76 and adapter-a 84 had been detached from one of apertures-e 82.

FIG. 13 is a rear view of the embodiment recited in FIG. 11. Rails 42 hold the top and bottom edges of gates-e 80. Adapter-a 84 has been wedged into one of apertures-e 82.

FIG. 14 is a section view taken along the line 14-14 of FIG. 13. Eyeglasses 78 are situated in front of cover-a 32, behind which rails 42 secure gates-e 80. Adapter-a 84 has been wedged into one of apertures-e 82.

FIG. 15 is a section view taken along the line 15-15 of FIG. 13. Clip 76, which is permanently joined to cover-a 32, functions as a wearing component by clamping a part of eyeglasses 78 so that relative positions are maintained. Clip 76 therefore enable the embodiment to be worn when eyeglasses 78 are worn.

As this invention is susceptible to embodiments in different forms, various features including those described above may be used independently or modified within the principle and scope of the invention. For example, the cover may be separated into two pieces, whereby each can be wedged into the rims of the frame. Also, the lenses may be tinted instead of reflective, may be permanently joined to the frame, may be permanently conjoined as a single unit, or may be a just a flat sheet of transparent plastic material. Furthermore, the wearing component may secure the cover in front of, instead of behind an eyewear, which may be sunglasses or goggles, instead of eyeglasses.

I claim:

1. A device for obstructing peripheral vision comprising:
at least a cover situated in front of the area within and surrounding the eye sockets, said cover including at least one viewing window with size and position encompassing a range of possible positions of pupils;
at least a gate selectively blocking a portion of said viewing window; and,
at least a repositioning mechanism enabling lateral repositioning of said gate.

2. The device of claim 1, wherein said repositioning mechanism is joined to said cover.

3. The device of claim 1, wherein at least said gate is translucent.

4. The device of claim 1, wherein said gate includes an aperture that enables vision through a portion of said viewing window.

5. The device of claim 4, wherein said gate is substitutable with another of said gate with aperture of different design.

6. The device of claim 4, wherein said aperture can be vertically repositioned.

7. The device of claim 4, additionally comprising at least one adapter for blocking a portion of said aperture.

8. The device of claim 1, additionally comprising a frame joined to said cover.

9. The device of claim 8, wherein said repositioning mechanism is joined to said frame.

10. The device of claim 1, additionally comprising at least one lens.

11. The device of claim 10, additionally comprising a frame joined to said lens.

12. The device of claim 10, wherein said lens reduces the amount of light transmitted.

13. The device of claim 1, additionally comprising a wearing component.

14. The device of claim 13, wherein said wearing component is joined to said cover.

15. The device of claim 13, additionally comprising a frame joined to said wearing component.

16. The device of claim 13, wherein said wearing component removably secures said device to eyewear.

17. The device of claim 1, additionally comprising a shield that is extended rearward so as to enhance obstruction of peripheral vision.

18. The device of claim 17, additionally comprising a frame joined to said shield.

19. A device for obstructing peripheral vision comprising:
at least a cover situated in front of the area within and surrounding the eye sockets, said cover including at least one viewing window with size and position encompassing a range of possible positions of pupils;
at least a gate that includes an aperture, selectively blocks a portion of said viewing window, and is substitutable with another of said gate with aperture of different design;
at least a repositioning mechanism enabling lateral repositioning of said aperture through repositioning of said gate;
a frame joined to said cover;
at least a lens that reduces the amount of light transmitted and is joined to said frame; and,
a wearing component joined to said frame.

20. A method for making a device for obstructing peripheral vision, said method comprising the steps of:
providing at least a cover situated in front of the area within and surrounding the eye sockets, said cover including at least one viewing window with size and position encompassing a range of possible positions of pupils;
providing at least a gate selectively blocking a portion of said viewing window; and,
providing at least a repositioning mechanism enabling lateral repositioning of said gate.
